(19) United States
(12) Patent Application Publication
(10) Pub. No.: US 2007/0013535 A1
(43) Pub. Date: Jan. 18, 2007

(54) Liquid low level warning device

(75) Inventors: Yueh-Ling Chiu, Taichung Industrial Park (TW); Wen-Chia Wu, Taichung Industrial Park (TW)

Correspondence Address: CHARLES E. BAXLEY, ESQ., 90 JOHN STREET, THIRD FLOOR, NEW YORK, NY, 10038, US

(73) Assignee: Hiwin Technologies Corp.

(21) Appl. No.: 11/182,450

(22) Filed: Jul. 15, 2005

(51) Int. Cl. G01F 23/32

(52) U.S. Cl. 340/612

(57) ABSTRACT

A liquid low level warning device is used on the nut of a screw bolt or the slide block of a linear guideway, and comprises: a circuit terminal, rail and buoyage. The terminal is disposed on a lubricating device in such a manner that an end of the terminal is electrically connected to external equipment (by wire or wireless means) and another end is connected to the rail and positioned in the receiving space of the lubricating device. A stop block is provided on the upper end of the rail and the buoyage is moveably mounted on the rail. With such arrangements, the liquid low level warning device will produce alarm signals when the lubricating oil is lowered to a predetermined level.

### BACKGROUND OF THE INVENTION

1. Field of the Invention

The present invention relates to a liquid low level warning device that is used on a nut of a ball screw or on a lubricating device at either side of a slide block of a linear guideway.

2. Description of the Prior Arts

With the development of science and technology, and the improvement of the precision feeding system, linear guideway and technology thereof have become a most important part of many precision mechanisms. Various types of linear mechanisms have been and are being widely used in different fields. Although the linear guideway technology is developing fast, still, there are some problems of the linear products that need to be improved. Many efforts have been made by the related industry to improve the quality of linear guideway, in particularly, for those high precision mechanisms (such as wafer processing equipment and CNC Computer Numeric Control instruments) that need to run stably and silently. Therefore, there are still some blind spots in the existing linear mechanisms that need to be exploited and erased.

Conventionally, a bolt screw or the slide block of a linear guideway is provided at either end thereof with an lubricating device for storage of lubrication, as shown in FIG. 1, the oil tanks 11 at either side of the bolt screw 10 serves to provide lubrication for the linear guideway. This type of linear guideway has been used for a long time, however, it still has some disadvantages as follows that need to be improved.

First, the ball screw 10 and the oil tanks 11 are so small that the oil level thereof is difficult to be checked accurately by naked eye.

Those abovementioned liquid level indicating devices are large, complicated and expensive, they are unsuitable for use in super small oil tank,

Second, the existing liquid indicating devices can be used on the lubricating device are generally divided into two types: the first one is to detect the liquid level by using ultrasonic waves, and the second one is to fix a pressure gauge to the bottom of the lubricating device.

The present invention has arisen to mitigate and/or obviate the afore-described disadvantages.

### SUMMARY OF THE INVENTION

The primary objective of the present invention is to provide a liquid low level warning device capable of indicating the liquid level accurately and easily. The liquid level warning device comprises circuit terminal, rail and buoyage, the circuit terminal serves to connect external equipment (such as buzzer, control system or lamp), when the lubricating oil reaches a predetermined low level, the buoyage will block infrared transmission between the infrared emitter and the infrared receiver.

The primary objective of the present invention is to provide a low cost and compact liquid low level warning device, wherein the circuit terminal can emit signal to the external equipment in a wire or wireless manner.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 shows a conventional ball screw device;

FIG. 2 is a perspective view of a liquid low level warning device in accordance with a first preferred embodiment of the present invention;

FIG. 3 shows a lubricating device in accordance with the first preferred embodiment of the present invention;

FIG. 4 is an operational view of showing the liquid low level warning device in accordance with the first preferred embodiment of the present invention;

FIG. 5 is another operational view of showing the liquid low level warning device in accordance with the first preferred embodiment of the present invention;

FIG. 6 is a perspective view of a liquid low level warning device in accordance with a second preferred embodiment of the present invention;

FIG. 7 is an operational view of showing the liquid low level warning device in accordance with the second preferred embodiment of the present invention;

FIG. 8 is another operational view of showing the liquid low level warning device in accordance with the second preferred embodiment of the present invention.

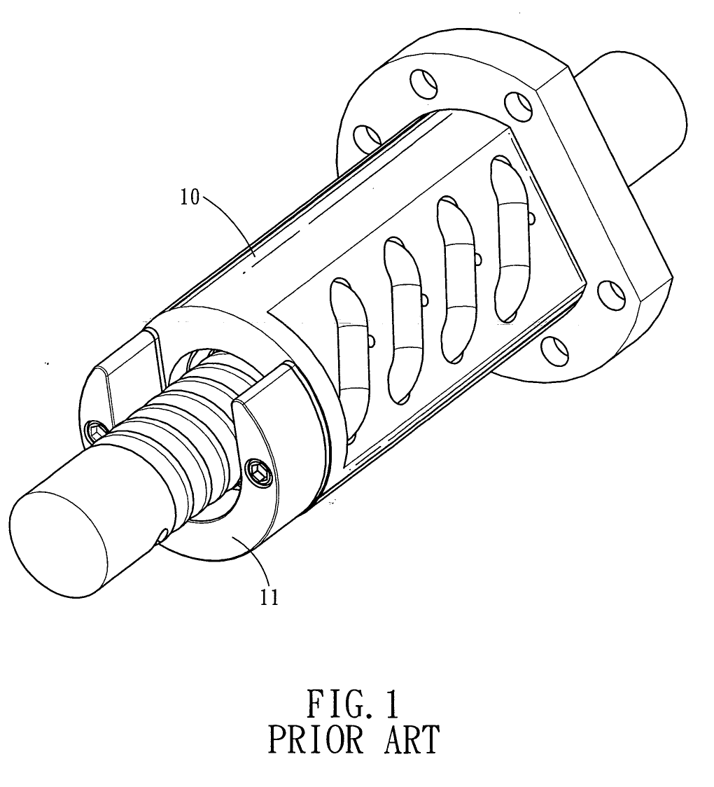

### DETAILED DESCRIPTION OF THE PREFERRED EMBODIMENTS

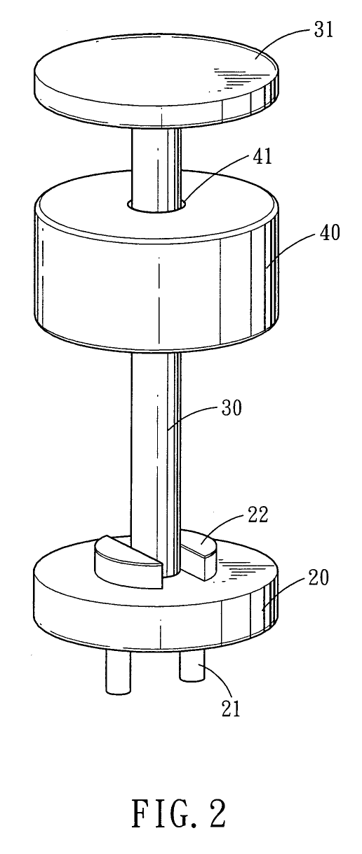

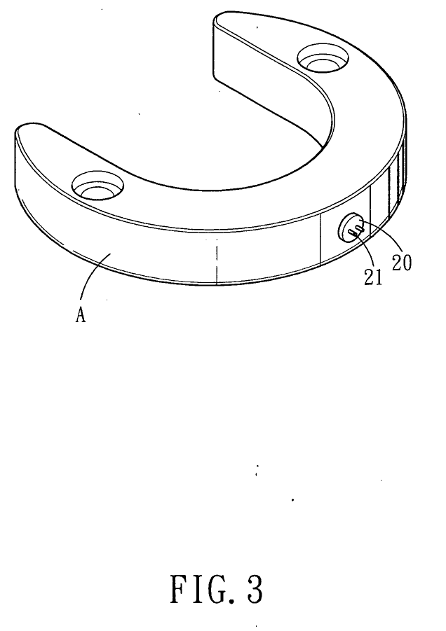

Referring to FIGS. 2-4, a liquid low level warning device in accordance with a preferred embodiment of the present invention is shown and comprises a circuit terminal 20, a rail 30 and a buoyage 40.

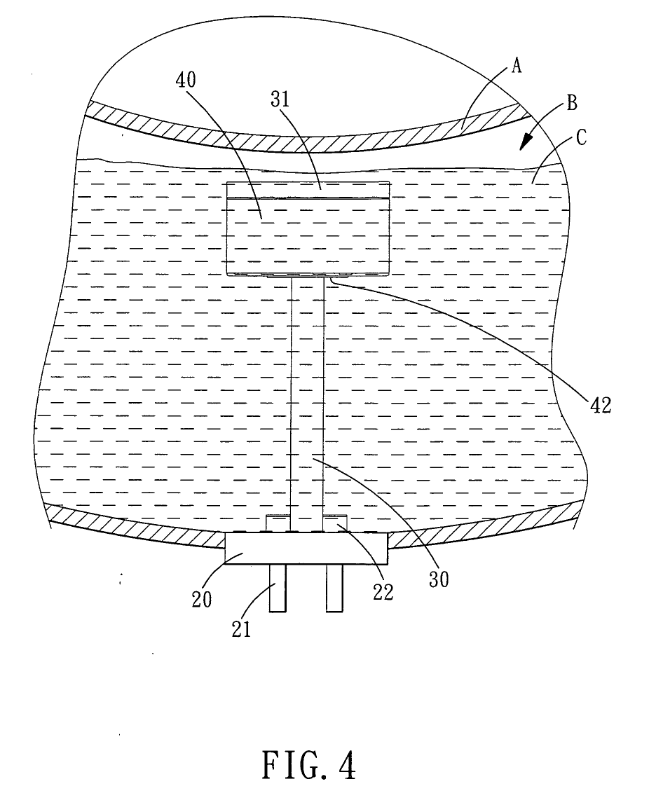

The circuit terminal 20 is fixed to the wall of an lubricating device A, two pins 21 at a first end of the circuit terminal 20 are to be electrically connected to external equipments (such as buzzer, control system or lamp) in series, and two semicircular metal plates 22 at a second end of the circuit terminal 20 are connected to the inner space B of the lubricating device A and act as an electrical connector (as shown in FIG. 4).

The rail 30 is a cylindrical member positioned in the inner space B of the lubricating device A, a first end of the rail 30 is connected to the circuit terminal 20 and located between the two semicircular metal plates 22, and at a second end of the rail 30 is provided a stop block 31.

The buoyage 40 is a cylindrical member having a through hole 41 through which the buoyage 40 is slidably mounted onto the rail 30, and a cross section of the through hole 41 is larger than that of the rail 30. To the bottom of the buoyage 40 is fixed a conductive metal piece 42 employed to electrically contact the semicircular metal plates 22 of the circuit terminal 20. The buoyage 40 is less than the lubricating oil C in density.

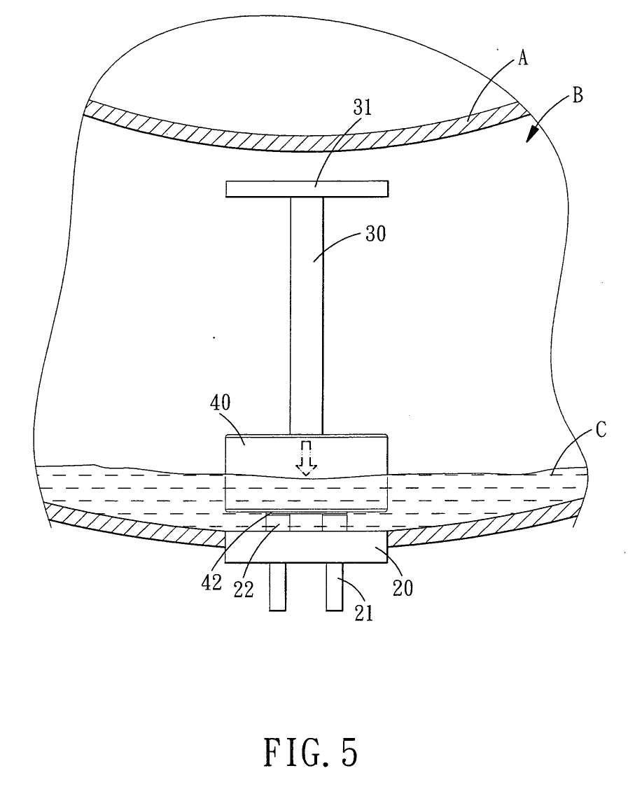

For a better understanding of the present invention, its operation and function, references should be made to FIGS. 4 and 5. As mentioned above, the buoyage 40 is confined on the rail 30 by the cooperation of the stop block 31 and the through hole 31, and the conductive metal piece 42 of the buoyage 40 is employed to electrically contact the semicircular metal plates 22 of the circuit terminal 20. If there is enough lubricating oil C left in the inner space B of the lubricating device A, the buoyage 40 will float on the lubricating oil C due to its light density, and the conductive metal piece 42 of the buoyage 40 is unable to contact the semicircular metal plates 22 of the circuit terminal 20. Therefore, no alarm will be generated.

On the other hand, if the level of the lubricating oil C is too low (close to the bottom of the inner space B of the lubricating device A), the buoyage 40 will move down as a result of the fall of the lubricating oil level, until the conductive metal piece 42 of the buoyage 40 contacts the semicircular metal plates 22 of the circuit terminal 20. At this moment, the pins 21 of the circuit terminal 20 will output signal to the external equipment (such as buzzer, control system or lamp), and thus alarm will be triggered.

In addition, the liquid low level warning device of the present invention is small and simple structured as compared to the corresponding prior arts. In practical terms, the diameter and the height of the low level warning device of the present invention can be minimized to 15 mm and 20 mm, respectively. It must not be smaller than this minimum size, the buoyage then has enough weight to make itself substantially contact the circuit terminal, and to overcome the non-conductive oil film of the lubricating oil.

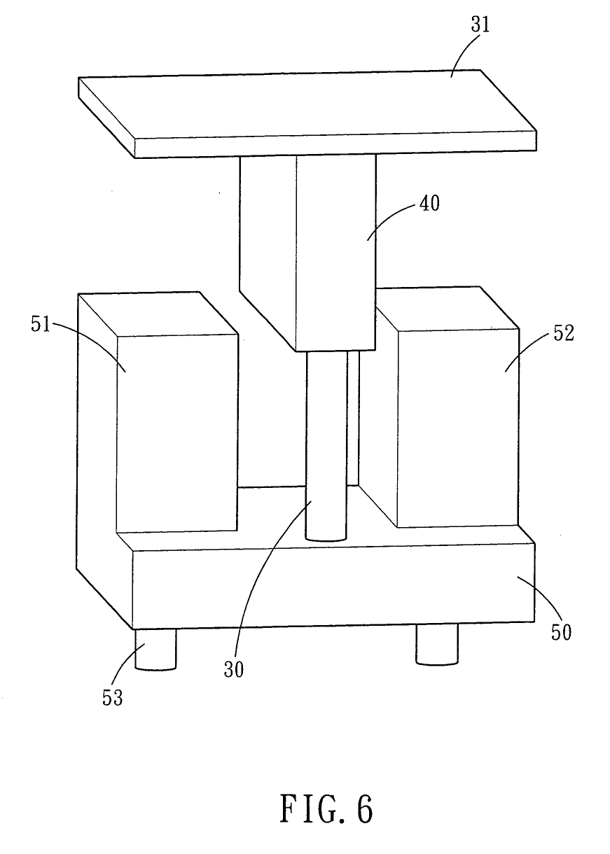

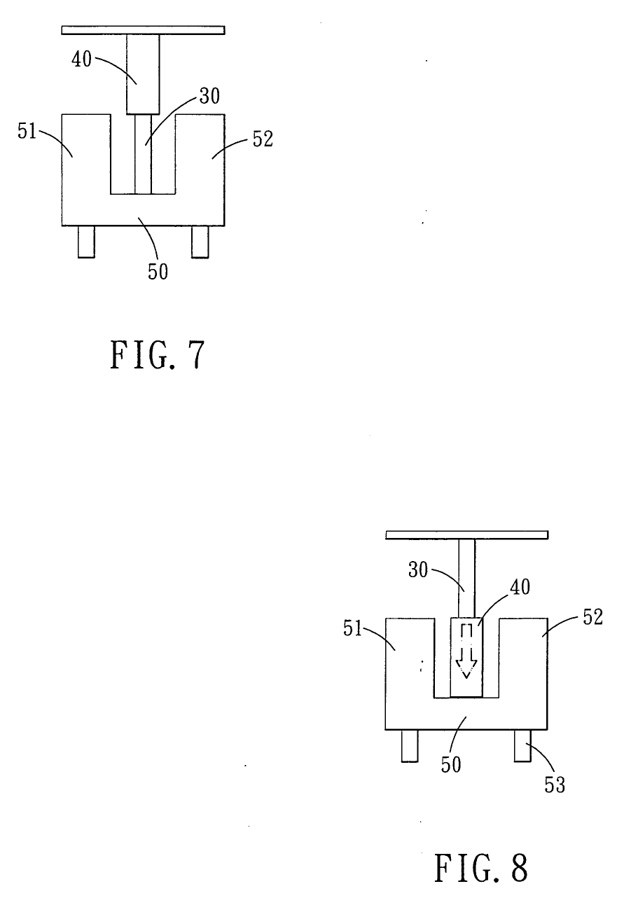

To obtain a more smaller but useful liquid low level warning device, references should further be made to FIGS. 6, 7 and 8, which shows a liquid low level warning device in accordance with another preferred embodiment of the present invention. In this embodiment, the circuit terminal 20 is replaced with a photo-interrupter type terminal 50 that is a well-known electronic product having a pair of opposite protrusions formed in the lubricating device. One of the protrusions is an infrared emitter 51 and another one is an infrared receiver 52. When the buoyage 40 is in a raised position (as shown in FIG. 7), the infrared between the infrared emitter 51 and the infrared receiver 52 is unblocked. And when the buoyage 40 sink down (as shown in FIG. 8), the infrared between the infrared emitter 51 and the infrared receiver 52 will be blocked. As a result, the photo-interrupter type terminal 50 will output signal to the extern equipment (such as buzzer, control system or lamp) through the metal pins 53, and thus alarm will be triggered.

The function of the photo-interrupter type terminal 50 has nothing to do with the weight of the buoyage 40, and in practical terms, the size of the low level warning device of this embodiment can be minimized to 10 mm³.

The metal pins of the circuit terminal 20 also can be replaced with a signal-emitting device that can emit signal to the external equipment (such as buzzer, control system or lamp) in a wireless manner.

Since the buoyage and the circuit are of known arts, further explanations are omitted, and other details of the present invention are explained as follows:

First, the buoyage produces a mechanical input and then it is turned into an electrical output by the circuit, thus creating a low cost and compact liquid level warning device.

Second, since the turn on/off of the alarm is controlled by the buoyage and the level of the lubricating oil, the density of buoyage should be less than that of the lubricating oil, and then it can float. The bottom of the buoyage associated with a contact type circuit must be made of conductive material, but not necessary for the buoyage associated with photo-interrupter type terminal 50.

Third, the circuit terminal is equivalent to a switch of a circuit, when the buoyage reaches the warning level, the switch will be turned on. In normal condition, the switch is off. For a contact circuit type level warning device, the circuit terminal 20 is made of conductive material.

While we have shown and described various embodiments in accordance with the present invention, it should be clear to those skilled in the art that further embodiments may be made without departing from the scope of the present invention.

What is claimed is:

1. A liquid low level warning device employed to be mounted on a lubricating device of a linear system, the lubricating device having an inner space for storage of lubricating oil, and the liquid low level comprising:
a terminal fixed to the lubricating device and having a first end connected to an external equipment and having a second end connected to the inner space of the lubricating device;
a rail positioned in the inner space of the lubricating device and having a first end connected to the terminal and having a second end provided with a stop block; and
a buoyage slideably mounted on the rail and serving to control turn on/off of the terminal, and a density of the buoyage is less than that of the lubricating oil.

2. The liquid low level warning device as claimed in claim 1, wherein the terminal is a circuit terminal fixed to a wall of the lubricating device, a plurality of pins at the first end of the circuit terminal are to be electrically connected to the external equipment, and a plurality of metal plates acting as electrical connectors are arranged at the second end of the circuit terminal and are connected to the inner space of the lubricating device;
the rail is a cylindrical member, and the first end of the rail is connected to the circuit terminal; and
the buoyage is a cylindrical member having a through hole through which the buoyage is slidably mounted onto the rail, and a cross section of the through hole is larger than that of the rail, to a bottom of the buoyage is fixed a conductive metal piece employed to electrically contact the semicircular metal plates of the circuit terminal.

3. The liquid low level warning device as claimed in claim 1, wherein the circuit terminal a photo-interrupter type terminal having a pair of opposite protrusions, one of the protrusions is an infrared emitter and another one of opposite protrusions is an infrared receiver, when the lubricating oil reaches a predetermined low level, the buoyage will block infrared transmission between the infrared emitter and the infrared receiver.

4. The liquid low level warning device as claimed in claim 2, wherein two metal plates are disposed at the second end of the circuit terminal, and the first end of the rail is positioned between the two semicircular metal plates.

5. The liquid low level warning device as claimed in claims 1, 2 or 3, wherein the external equipment is a buzzer.

6. The liquid low level warning device as claimed in claims 1, 2 or 3, wherein the external equipment is a control system.

7. The liquid low level warning device as claimed in claims 1, 2 or 3, wherein the external equipment is a lamp.

8. The liquid low level warning device as claimed in claims 1, 2 or 3, wherein the terminal is provided with a signal-emitting device that can emit signal to the extern equipment.

9. The liquid low level warning device as claimed in claims 1, 2 or 3 is used on a nut of a ball screw.

10. The liquid low level warning device as claimed in claims 1, 2 or 3 is used on a lubricating device at either side of a slide block of a linear guideway.
